(19) United States
(12) Patent Application Publication
(10) Pub. No.: US 2023/0372829 A1
(43) Pub. Date: Nov. 23, 2023

(54) METHOD AND SYSTEM FOR MULTI-PLAYER ONLINE WORD LOGIC GAMES

(71) Applicant: Frank S. MAGGIO, Seminole, FL (US)

(72) Inventor: Frank S. MAGGIO, Seminole, FL (US)

(21) Appl. No.: 18/200,528

(22) Filed: May 22, 2023

Related U.S. Application Data
(60) Provisional application No. 63/344,548, filed on May 21, 2022.

(51) Int. Cl. A63F 13/822; A63F 13/46; A63F 13/52

(52) U.S. Cl. CPC A63F 13/822; A63F 13/46; A63F 13/52

(57) ABSTRACT

A system and method are provided for implementing a uniquely automated, and otherwise gamified, version of a Multi-Player Word Logic Game. The disclosed schemes incorporate technology for hosting on, or interacting/reacting with, potential participants' mobile and personal communicating and computing devices. The disclosed schemes simplify hosting of, and participation in, a unique implementation of a Multi-Player Word Logic Game in a unique and interactive head-to-head participation scheme among pluralities of players.

This application claims the benefit of U.S. Provisional Patent Application No. 63/344,548 entitled “Method And System For Multi-Player Online Word Logic Games” by Frank S. Maggio, filed in the U.S. Patent and Trademark Office on May 21, 2022, the disclosure of which is hereby incorporated by reference herein in its entirety.

### BACKGROUND

### 1. Field of the Disclosed Embodiments

This disclosure is directed to a method and system for implementing a scheme by which enthusiasts of word logic puzzles, such as those perpetuated via on-line and mass media operators, can compete in a head-to-head manner, and in a manner by which large tournaments may be facilitated and organized, and prizes may be awarded to players based on a commonly-supported scoring system, which may provide player stratification and a tournament structure that rewards players based on, among other things, the players' demonstrated word logic skills and mastery of vocabulary.

### 2. Related Art

Globally, mass media advertising has evolved into a trillion-dollar annual industry. Through advertising, brands and agencies attempt to convey information to consumers in a manner that creates interest in the advertised products. This objective is often most ideally achieved by presenting advertising content in a powerful and repeated manner that may be designed to motivate consumer purchase and repurchase of specifically-advertised products.

Mass media advertising has likewise evolved from the nascent days of radio as the delivery medium, through the emergence and expansion of television as the modern “conventional” or “preferred” medium to reach mass audiences for entertainment, and therefore the growth of advertising. The evolution continues. Over at least three generations, advertising-supported media has proliferated, and the amount and/or frequency of advertising has expanded greatly as the delivery media have changed and evolved. Three network news and entertainment stations have, for example, evolved into dozens and dozens of news, entertainment, sports, advertising and other channels.

Today, there is further expansion in the media by which to reach the consuming public, including via delivery of all versions of advertising-supported media to individual users' personal electronic devices. These include desktop, portable and tablet computers, mobile cellular telephones, smart phones, and all manner of, for example, fixed-location changeable electronic displays. Consumers, particularly those that carry one or more portable personal electronic devices, which now may include wearable input/output (I/O) devices, have become increasingly drawn to actively using these portable personal electronic devices, even in environments once primarily used for passively watching television. Consumer portable personal electronic devices accompany the users at almost all times, providing the users with the ability, and the increasingly insatiable opportunity, to multi-task in acquiring and sharing information in real-time user-involved information exchange experiences.

Real-time user-involved information exchange experiences include virtually all manner of electronically-enabled communication activities, including, but not limited to, engagement with social media, electronic gaming (including group participation in such gaming) for active entertainment experiences, selection of particular media content for passive entertainment experiences, and information exchange through information exchange applications, including email, messaging applications, social media and other forms of user-to-user (or user-to-a collective of users) communications.

Engagement, via the individual users' personal electronic devices, continues, and often dominates, even as the users are exposed to advertising presented on televisions. Consumers have developed a near twitch-like response to multi-task, or “otherwise” engage, when advertising, which is often considered disruptive, interrupts them, like an uninvited guest. In this manner, the consumers tend to ignore the advertising even to the point of annoyance.

At the same time, there is an emerging trend toward increasing active user participation in web sites and mobile applications that provide crossword game enthusiasts with the ability to compete against one another over extended time periods, by creating and “playing” words derived from a finite set of letters in their possession. These crossword games tend to attract and recognize players (typically by awarding badges and displaying data including win/loss records) with a greater mastery of a game's standard language's vocabulary (i.e., English), and creativity in playing words using letters of different point values (increasing in value based on the infrequency of a letter in common use, such that a common letter like “E” may be assigned a 1 point value, while a rare letter like “Z” may be assigned a 10 point value).

More recently, word game enthusiasts have flocked to certain proprietary “word logic” games, where players are challenged to solve one or more “mystery” words of pre-determined length (i.e., 5 letters) over a finite series of “guesses.” According to a popular scheme, players are provided with clues as to correctness of guesses, by denoting which (if any) letters are correctly located within the mystery word, and which (if any) are found in the mystery word but are not correctly located within the guessed word (i.e., if the mystery word's second letter is an “A,” but the guessed word has an “A” in the third position).

Word logic games have grown in popularity in large part because the games tend to provide quicker solutions to completing the presented word puzzles when compared to the lengthier game play of extended crossword games. Word logic games can be solved (or may stump a player) generally after, for example, six or fewer guesses, or over the course of less than five minutes. Because of the clues provided with each guess, players are challenged to use logic to solve the mystery word, which provides a novel form of stimulation when compared to crossword games. Moreover, on platforms where up to millions of players can access the same mystery word each day (or in a particular period of time), there is a common unifying means by which players can compare themselves to others playing the same word logic game.

Communal word logic games have become wildly popular, to the point where, for example, television personalities are even playing the games on-air, and social media has become a means by which individual players can brag about the individual players' achievements, such as, for example, how few guesses (or even how quickly) the individual players were able to solve that day's mystery word. The mystery words are typically created by a game host, so while each individual player that day, or in that interval of time, is able to compare the individual player's results to everyone else, there is very little means of differentiation. As an example, an individual player can brag that the individual player was able to solve the mystery word in three guesses, or in under two minutes, but there is currently no practical ability to provide long term benchmarks so that individual players can rise among the ranks of player peers in what may be considered a meaningful or measurable way. In this regard, an ability to differentiate between tiers of player expertise may add passion and commitment to continued game play.

Another drawback of currently available word logic games is that any individual player is generally unable to actually play head-to-head against another individual player or group of players. An ability of one player to select the mystery word the competitor will solve, for example, may allow one player to truly compete in more aspects of a match than simply solving the same word. A player may thus develop a level of excitement as the player observes a competitor's attempts to solve the mystery word, while also learning about the solving strategy of the competitor.

The limited “reward” for playing daily word logic games is bragging rights drawn from an accumulation of data associated with a player, based on correctly solved puzzles (i.e., 95 of 100 puzzles solved for a 95% grade), winning streaks (number of consecutive correctly solving each day's mystery puzzle(s)), and consecutive days played (regardless of whether the puzzles are correctly solved). Word logic games (where multiple players may attempt to solve a series of identical mystery words at the same time, with the player solving correctly longer and outlasting all competitors being the victor) also provide a heightened level of accomplishment by competing in real time with players who are solving the same sequence of mystery words.

Word logic games generally employ a finite vocabulary, which is, for example, a portion of all known words containing a defined number of letters (i.e., five letters). By way of example, while there are in excess of 12,000 5-letter words valid for play inside crossword games, game hosts may limit the number of eligible words to roughly 2,500 words, removing little-known words, or words that may be considered “offensive” to some players.

Other word logic games may promote a restricted, themed vocabulary providing only unique thematically related words to be solved. Word logic games of this nature are attractive to only a subset of the total available audience, and while potentially availing themselves to words not available in the standard vocabulary (including proper nouns of fictious cities and people, for example), in many instances the total number of words eligible for use as a mystery word is significantly reduced over the “standard” vocabulary, thereby limiting the number of unique iterations before duplication.

An ability to allow advanced word logic game players to access a larger pool of “permitted” words may provide additional means of stimulating competition between players. Separately, a point value of a word may be derived based upon the infrequency of use of the word in everyday writing or conversation. In an attempt to derive a point value of a word, points may be assigned based on letter values (as with crossword games), as well as to point values for elements of a word that may tend to make it harder to solve (such as double or triple letters). Before solving a mystery word, the point value of the mystery word (or a point range, say 10-15 points for a mystery word worth 12 points) may be revealed to players, providing a potential clue about the mystery word, and affecting the logic of guessing and solving the mystery word.

The current universe of word logic games lacks methods and game mechanics necessary to stimulate and promote long-terms competition between players. Another drawback to conventional implementations lies in an ability to cheat. Once the communal mystery word is known, it can be found on the web at myriad sites who post that day's mystery word (and often by players who desire to share the individual player's guesses and strategy).

Popular word logic games are, therefore, sources of light fun. Based, however, on the current limitations or drawbacks, these currently popular word logic games (a) may be considered to lack the seriousness to warrant cultural sustainability, and (b) may not be considered to be able to support a prize pool that could attract even more excitement from a large population of available players.

Access to word logic games, and the cost of hosting the infrastructure to allow many players to play the game, is typically made available in exchange for the collection of user data, subscriptions, and/or insertion of advertising content (the cost of which is subsidized by brands seeking consumer attention).

Advertising content deployed in this manner tends to frustrate a player who may simply wish to play a word logic game without distraction or interruption. Insertion of advertising content then may represent an annoying distraction or interruption. While players recognize that tolerance of the advertising may the “price of admission” in order to play the word logic game, a certain insurmountable animus may be created by requiring players to delay game play. This animus does not aid the brand in winning over the player as a regular consumer. As with most advertising, it is seen as “un-content” when compared to the content that attracted the players to the word logic games.

### SUMMARY

It may be advantageous, in view of the above limitations of currently available word logic games, to develop methods by which players may compete against one another in a scheme that allows players to participate in both the creation of mystery words, and the solving of mystery words. In doing so, a player may otherwise be able to determine guessing patterns and strategies employed by the player's competitor to solve words, such that in subsequent competitions, the player could use the strategy displayed to create mystery words that are more difficult to solve.

It may be advantageous to provide one or more schemes that allow for the ability to award points to word logic mystery words, and to the method of solving, such that speed of solving, the number of turns required to solve, and/or the difficulty of the word based on letter choice and solving difficulty. Any of these options may allow for calculation of a resultant score from each interaction, and a basis for a long term means of creating an equivalence that may be loosely analogous to, for example, a golf or other competitive scoring handicap based on proficiency. This longer-term player rating scheme and resulting stratification may allow for players to rise or fall when competing with others, allow for creation of teams, leagues, tournaments, and allow for creation of a more widely accepted (and embraced) player rating system.

It may be advantageous, in view of the above limitations of currently available and proposed word logic games, to enable players of a greater demonstrated skill set to compete with others of similarly-demonstrated skills. One manner by which this may manifest itself is by opening up a broader and more difficult list of approved words from which to draw individual mystery words to be solved. A method of dividing the universe of words into ranges of difficulty and sharing the pools of approved words with certain players as those certain players gain in skill, may provide a level of seriousness and difficulty that would attract fans of more rigorous word games such as crossword games, who would otherwise not participate in the simplified word logic games popular today.

It may be advantageous, in view of the above distractive nature of the advertising embedded within word logic games, to find some manner by which to harness that distraction and interest in the adrenalized sensation of competing in head-to-head word logic games. By adding, for example, a “reactive” gamification component to the viewing of embedded advertising within the word logic game, a player may gain an advantage in the word logic game, such as more time to solve a puzzle, a clue, an extra round for solving, or the like. With presentations of reactive advertising, a player may be engaged in a manner that tends to reduce the willingness of the player to “tune out” the advertising content, thus rendering the advertising content more valuable to the advertiser as well as to the player.

Exemplary embodiments of the systems and methods according to this disclosure may provide an entertaining, rewarding, and effective manner by which to deliver word logic games embedded with reactive advertising to an audience of users/consumers with a scheme that attracts larger audiences, and that directly measures user/consumer interaction with the advertising content while collecting information on user/consumers in a non-obtrusive, fun and potentially rewarding manner.

Exemplary embodiments may transform currently available and proposed daily word logic game play from a light casual experience centered around solving a “centralized” word with very little competitive vigor, into an exciting daily, weekly or extended gaming experience allowing for rigorous competition, tournaments, rankings, and even significant prizes generated from a portion of the embedded reactive advertising revenue.

Exemplary embodiments may enable communities of players to compete at a local level, providing a more localized sense of community while still enabling regional, national and international competitions and tournaments to be generated between ranked players drawn from the local communities.

Objectives of the disclosed schemes may include increasing active and repeated participation in competitions between players/consumers and interaction with advertising content, and advancing user/consumer entertainment by making head-to-head word logic game play more attractive than traditional word logic game play, while making advertising content less distractive, and promoting advertising immersion through willingness on the part of the players/consumer to engage.

These and other features, and advantages, of the disclosed systems and methods are described in, or apparent from, the following detailed description of various exemplary embodiments.

### BRIEF DESCRIPTION OF THE DRAWINGS

Various exemplary embodiments of the systems and methods for uniquely automating and otherwise gamifying a Multi-Player Word Logic Game that incorporate technology, such as hosting on mobile and personal communicating and computing devices in a manner that simplifies hosting and participation according to this disclosure, will be described, in detail, with reference to the following drawings. The disclosed systems and methods may implement a scheme where various embodiments form a competitive new word logic game. For the purposes of this disclosure, “WORDIO” (all caps) shall refer to a word logic game that uses some or all of the various embodiments disclosed herein, and “Wordio” shall refer to a word to be created or solved within a WORDIO game as shown in the following drawings in which:

FIG. 1A schematically illustrates an exemplary embodiment of Wordio letter values such as those that may be similar to those used in crossword games, such that letters may have exemplary values in Multi-Player Word Logic Games that may be automated according the disclosed schemes;

FIG. 1B schematically illustrates an exemplary embodiment of a Wordio scoring model to demonstrate how various Wordio values may be derived through and automated Multi-Player Word Logic Game according the disclosed schemes;

FIGS. 1C and 1D schematically illustrate an example of a WORDIO game between two players (a First Player 140 and a Second Player 160) that may be automated according the disclosed schemes;

FIG. 2 illustrates a block diagram of an exemplary system for implementing an automated Multi-Player Word Logic Game according to this disclosure; and

FIG. 3 illustrates a flowchart of an exemplary method for implementing an automated Multi-Player Word Logic Game according to this disclosure.

### DETAILED DESCRIPTION OF EMBODIMENTS

Access to a WORDIO may be provided to users of mobile devices or internet-connected computers via internet-connected mobile apps and web sites, whether centralized (i.e., a single application or associated web site), or accessed via “white label” applications and web sites. The results of WORDIO competitions, the compilation of results over time, adjudication of winners, application of a ranking system, registration of players, integration with advertisers creation of reactive contesting and prize awards may be centrally hosted or may be decentralized across myriad publishers and hosts, or any combination thereof.

WORDIO may provide players with a head-to-head word logic puzzle, where two or more players attempt to solve a multi-letter Wordio created by an opponent, as quickly and in as few “attempts” or “rounds” as possible. The number of letters in a Wordio may vary, and the number of players competing with one another over a WORDIO session may be greater than two, and a single player may compete against artificial intelligence that can simulate the head-to-head competition.

For the purposes of this disclosure and descriptions, we will use exemplary 5-letter Wordios, played between, for example, two players.

Contestants may be pre-registered or play as guests; in one embodiment, registration may be required to compete and to obtain and gain points over repeated play. In order to discourage cheating, collections of points, rankings, tracking of streaks and potential of winning prizes may be limited to competitors who are randomly or anonymously matched.

Once players are matched, a WORDIO battle plays out over two or more stages, including:
a. Wordio Creation in which a player creates a Wordio. The Wordio may be created from a list of approved 5-letter words. A lexicon of approved words may vary based upon the skills and levels/rankings of competing players.
b. Advertising engagement may be introduced by the WORDIO battle host or publisher electing to insert traditional, or various other forms of, reactive advertising content during the WORDIO battle. In embodiments, reactive advertising may precede the battle with, for example, each individual participating player being served a reactive advertisement followed by one or more queries. The queries may take the form of surveys or polls (where selecting any choice would fulfill a bonus requirement), or the queries may take the form of questions designed to test the attention and comprehension of the player to the advertising content, where a correct response would fulfill a bonus requirement. In embodiments, players may learn immediately of the “correctness” of the response to the queries. In the event of an incorrect answer, a player may be afforded one or more extra (“mulligan”) attempts, which may award the same or reduced bonus value on a second or subsequent attempt to obtain a correct answer. In embodiments, advertisers may be exchanged for other advertisers, different commercials by the same advertiser may be served, or different queries about the same advertising content may be presented.
c. Bonus Selection may, in embodiments, be implemented by a player who has earned a bonus from a separate advertising engagement stage electing to increase an amount of time designated to solve the Wordio, to increase a number of permitted rounds to solve the Wordio, a reveal of one or more letters and/or their location within the Wordio to be solved, a reveal of a full point value of the Wordio to be solved, or some other advantage to assist in solving the Wordio more quickly or easily, or another advantage. In embodiments, where a player choice must be made between additional solving time, or an additional round, to solve, the player choice may be entered prior to commencing the solving of the Wordio. In embodiments, the player choice to add time or additional rounds may be made during the solving process.
d. Player Sequence Selection may be implemented by players taking turns and/or revealing the created Wordio be solved by the competitor, thus providing suspense as multiple Wordios are solved in sequence, as opposed to simultaneously. In embodiments where players take turns, a first to play may be selected randomly, or based on allowing a player with the most difficult Wordio to solve (as determined by the system or method) to go first, or last. In embodiments, player sequence may be based on player strength, winning streaks, average scores, or other data points that illustrate differences in skill, frequency or longevity of play between players. In embodiments, players may bid points to go first or last (e.g., via an auction where, for example, a player agreeing to play first or last may agree to deduct or add points to that player's score or add or subtract time to solve that player's Wordio, with the highest or lowest bid enabling the player to solve first or last).
e. Wordio Solving may be implemented, for example, by each player being presented with a Wordio to be solved, along with an optional disclosure as to a point value (or point range) of the Wordio to be solved. An amount of time available to solve the Wordio may be displayed, as may a maximum number of rounds allocated to solve the Wordio. Players may commence solving the Wordio by submitting “guess” Wordios, with clues being provided as to letter correctness and letter location correctness. In embodiments, players may be precluded from entering Wordios that are misspelled or not found in an approved lexicon, or from resubmitting a Wordio previously submitted.
f. Wordio Clue Disclosure may be implemented, for example, when a player submits a Wordio guess, thereby completing a “round,” and feedback as to letter correctness may be provided. Such feedback may be provided in a form of color-coding letters based on “Perfect” correctness (correct letter and position within a Wordio, illustrated with a first color) and “Partial” correctness (correct letter, wrong position, illustrated with a second color). In embodiments, points may be awarded for each Perfect letter (e.g., 2 points) and lesser points awarded for Partial letters (e.g., 1 point). In embodiments, points may be awarded and a total disclosed and displayed (e.g., 5 points for two Perfect and one Partial letter), but no color coding may be provided, thereby adding a degree of difficulty. In embodiments, points may be disclosed and displayed, and letters that are either Perfect or Partial may be highlighted, but no differentiation in color may be provided.
g. Required incorporation of one or more Partial or Perfect letters in subsequent rounds may be implemented in embodiments in which one or all Partial or Perfect letters may be included in subsequent guesses in order to be submitted and scored. Alternatively, a penalty (e.g. 5 points) may be deducted from a score when violating this “rule.” This rule may be optional such that players may opt-in or opt-out of this rule when selecting an opponent, or when awaiting an opponent with which to be matched.
h. Scoring and Winner Declaration may be provided for each player who successfully solves a Wordio within specified round and time constraints, to include, for example, collecting points that increase based upon a combination of time remaining to solve, points for unused rounds, points for Wordio difficulty and points for letter values within a Wordio. In embodiments, should a player be stumped (i.e., not solve the Wordio within the round and time constraints), the stumped player may receive no points. In embodiments, the stumped player may retain some or all points derived from Partial or Perfect letters earned, unused rounds before time had lapsed, unused time after all rounds were expended, or points for the value of the stumped player's own created Wordio, in an event an opponent did not successfully solve the Wordio. The Winner of a WORDIO battle may be the player with the most points.
i. Rematch Options may be implemented as players may be provided an option of requesting or demanding a rematch, including a right to demand a rematch at a risk of a winning player forfeiting some or all of the winning player's points by not accepting the challenge. A benefit of allowing for rematches, or, in embodiments, playing a best-of-three or similar multi-game format, may be an application of strategy for future Wordio creations based on observations of how an opponent plays and guesses Wordios used. In embodiments, a player may only be permitted to play a Wordio guess, or to create a Wordio for solving once per match, or per day, or per other time interval. This variation may add competitive features not available in currently existing and proposed word logic games.

Player Registration may be implemented according to combinations of one or more of the following steps:
a. Players may be permitted to play anonymously (“Guest” mode), or by providing only limited information such as some combination of name, unique email address and/or telephone number, unique screen name and password, allowing for aggregation of points and ranking over time.
b. Players may elect to provide more information including address, age, gender, and other information that may be considered to be of value to advertisers. Fully registered players may be afforded benefits or privileges. The benefits or privileges may include an ability to play more frequently, permission to enter tournaments, an opportunity to obtain a local/national/global ranking, and be eligible for prizes, where Guest players, or those with minimal registration information, may not be afforded a concomitant opportunity to obtain some or all of these privileges and benefits.
c. When fully registering, a player may credit a “Buddy” (in embodiments, a previously registered WORDIO player) for introducing the player to WORDIO. In embodiments, a Buddy may be eligible for matching prizes when a player referred by the Buddy wins prizes.

An illustrative example of an embodiment of a Multi-Player Word Logic Game according to the disclosed seems may include the following steps:
a. Players may register to be eligible for game play at a web site hosted by a publisher.
b. Once registered and given access, the player may join a Wordio “green room” or staging area and create a 5-letter Wordio. The lexicon of available words may increase based on the player's ranking. There may be multiple lexicon levels, a methodology of which is described in more detail below.
c. Once a player creates a Wordio, a point value of the Wordio and a lexicon level may be shown. Players may CONFIRM or enter another Wordio. A point value of the Wordio may increase based on the Wordio difficulty. Players may consider the “double-edged” nature of creating a more difficult Wordio, e.g., if the Wordio is solved, the opponent keeps the points vs. if the opponent fails to solve the Wordio, the player may retain the points.
d. Once the Wordio is locked in, the player may REACT to a short “reactive” commercial, followed by a multiple-choice question about the Sponsor and/or the commercial. Correctly answering the question(s) associated with the commercial may provide the player with an option to add additional time to a base timeframe allocated to solve a competitor's Wordio, or may add an additional round (or rounds) to solve the Wordio, or may provide an ability to see a precise point value of the Wordio to be solved (as opposed to simply seeing, for example, a point range within which the Wordio to be solved falls). Results of the query (and eligibility for a bonus) may be revealed when Battle play commences.
e. After Reacting, the player may enter a virtual Studio, where all other contestants with whom the player may compete are viewable (e.g., at or below the player's level, with a Wordio within the player's lexicon range). Each eligible player may be listed by Avatar, Screen Name, Ranking, Record, and pending Wordio value range. Individual players may not see certain players not within the individual players' level. Players may wait to be challenged or may challenge others in the Studio (as in a “Curated” game) by sharing a unique studio passcode for the game with others. Players may be limited as to the number of challenges the players reject, being required to accept a subsequent challenge.
f. Alternatively, players may select an “Auto-match” or similar option, and the WORDIO platform may automatically select a “suitable” Challenger according to a prescribed scheme employing any one or more of the above-mentioned differentiators. Auto-match games and results may contribute to national rankings and prizes. Curated games and results (where competitors are selected) may affect records, but may be restricted from affecting national rankings and prize eligibility.
g. Once players are matched, the game may begin. PLAYER 1 may be the player that created the Wordio with the lowest Wordio point value. In embodiments, all Wordios may have a minimum point value of 10 points, and competitors may see only the point value range for Wordios in excess of 10 (including, in increments of 10, for example) with a player being provided an option of removing 5 seconds of time in exchange for seeing an actual Wordio value (e.g., 16 points vs. 20). Alternatively, players may see other player's total point value range, if in excess of 10 points.
h. If tied, a player with a highest average Wordio score may be Player 1.
i. Each player may see other players' actions in turn.
j. Before solving the Wordio, time may be put on the timer and 5 blank rounds may be shown. (NOTE: There may be bonus time allocated to a player that plays first, or last.)
k. Results of Player 1's Reactive Experience (“RXP”) may be revealed, and if correct, Player 1 may be allowed a timeframe to select either a time addition, an additional Round for solving, or a full reveal of the Wordio point value. Failure to timely select a presented option within the timeframe may result in a default selection, e.g., to adding an additional Round. Upon selecting, Player 1 may have another time period to submit a first Wordio clue, at which point the timer may commence.
l. The clock may begin counting down when a player submits a valid 5 letter Wordio. The game may reveal the letters that are PERFECT (correct letter and location) with a First Color highlight, and PARTIAL (correct letter, wrong location) with a Second Color highlight. The player may be awarded 2 points for each Perfect and 1 point for each Partial letter.
m. In embodiments, in ROUND 1 ONLY: If either player correctly solves the Wordio on the first Round, the game may be cancelled, and neither player may be credited with a game played.
n. Embodiments may allow the player to retain the points, and exceptional point values, gleaned from a Perfect first guess; however, odds of this occurring may generally be so rare that it may be considered more likely that there has been collusion. Certain embodiments may not allow for a Perfect first guess.
o. Player 1 may continue to submit new Wordio guesses each round in an effort to solve the competing Wordio.
p. SUCCESS may be achieved if Player 1 solves the Wordio, and Player 1 may earn a score equal to the addition of the following:
   i. 2 Points/Perfect letter, 1 Point/Partial letter (all Rounds except the final round)
   ii. The solved Wordio point value (minimum 10 points)
   iii. 10 Points for each unused Round
   iv. 1 point for every second of time remaining
   v. Player 2's FAILED Wordio point value (min. 10 points), where applicable.
q. FAILURE may occur if Player 1 is unable to solve the Wordio before the first of a) time running out, or b) depleting all several-prescribed rounds, Player 1 may retain only the Partial and Perfect letter points, and, where applicable, points from the Wordio if the competitor also fails to solve the Wordio on the upcoming turn.
r. Player 2 may then play the Wordio, following the same process as Player 1.
s. FINAL RESULTS may include the following: If both Players 1 and 2 succeed, the one of the players with the most points may be declared a winner. If both Players 1 and 2 score identical points, Players 1 and 2 may both declared to have scored a tie. If only one of Players 1 and 2 succeeds in solving the Wordio, that one of the players may automatically be declared a winner. If both players fail, the one of Players 1 and 2 with the highest score may post a TIE, and the one of Players 1 and 2 with the lower score may post a LOSS. If both failed players tie, each of Player 1 and 2 may post a LOSS.
t. A REMATCH may be commenced if, within a specified interval after the results are “posted” (e.g., 15 seconds), a first game's losing player seeks such a rematch via a challenge. The the first game's winning player may forfeit any “winnings” if the challenge is rejected, and may receive no benefit from the win, points, or streak continuation in such an instance. If the first game's losing player is victorious on the second (rematch) game, either player may demand yet another rematch, and if rejected, may forfeit the win and points. Embodiments may not add forced replay aspects.

Unique attributes of WORDIO over conventional word logic games may include one or more of the following:
a. WORD CREATION BY COMPETITORS: Words to be solved are conventionally created by a host and are typically identical for all players. WORDIO may add an element of competition and strategy, enabling players to select words to be solved.
b. SEQUENTIAL HEAD-TO-HEAD: Players (random or challenged) may each select a Wordio another player may solve, and may be able to compete with others multiple times a day while accessing practice games, as opposed to only once per day or increment of time for many word logic games. Players may be able to watch in real time as the Wordios are solved and may be able to learn about competitor's strategies as well.
c. STRATEGY: WORDIO game play is impacted by Wordio difficulty, expertise and results of a player's opponent's game. Players may balance speed of play with available rounds and time to solve.
d. PLAYER PROFILES: Before Round 1, competing players may learn some or all of the following about each other:
   i. Avatar, Screen name, City, State, gender and a rank with badge icon (e.g., 1 to 5 stars)
   ii. Average points per game, win-loss-tie record (and %), and current winning streak.
   iii. Head-to-head record (where applicable)

Wordio Point Values: Wordio point values may increase in value based upon their difficulty.

In embodiments, a minimum point value for a Wordio may be established (e.g., 10 points), so that any Wordio valued at 10 points or less would be disclosed as worth 10 points, adding to the difficulty in solving by obfuscating the identity of some letters with higher values.

Wordio values may exceed the minimum point value based on certain criteria.

Scoring of Wordios may be according to any or all of the following criteria.

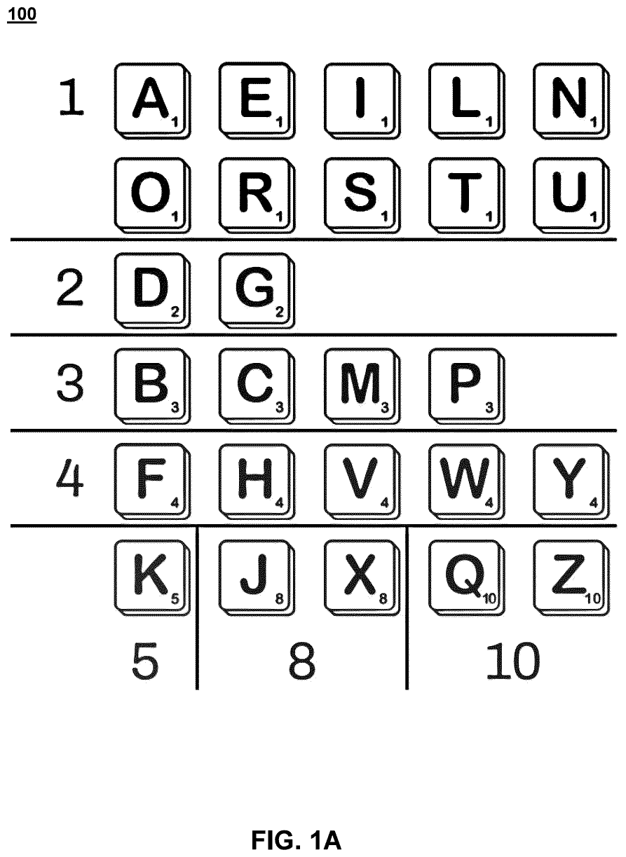

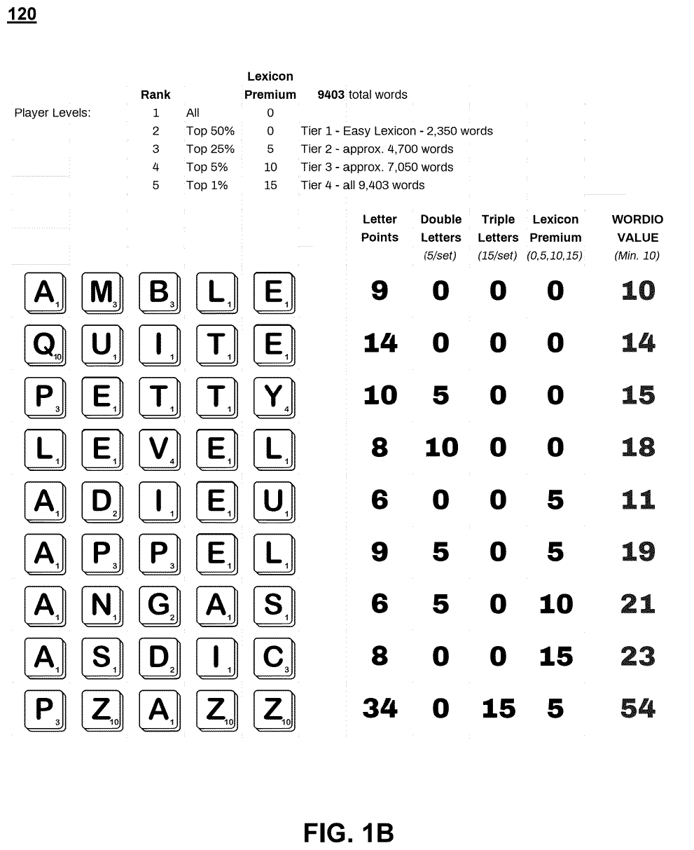

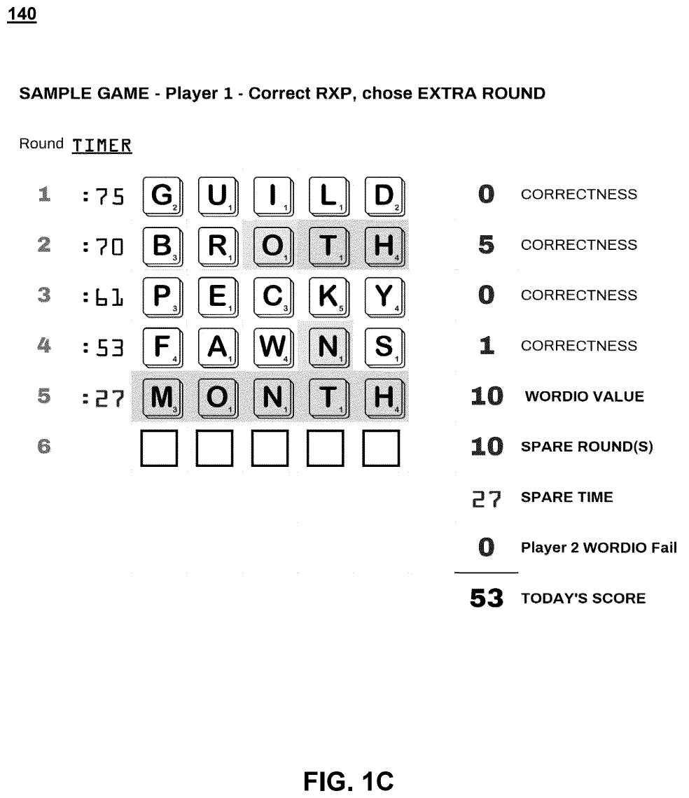

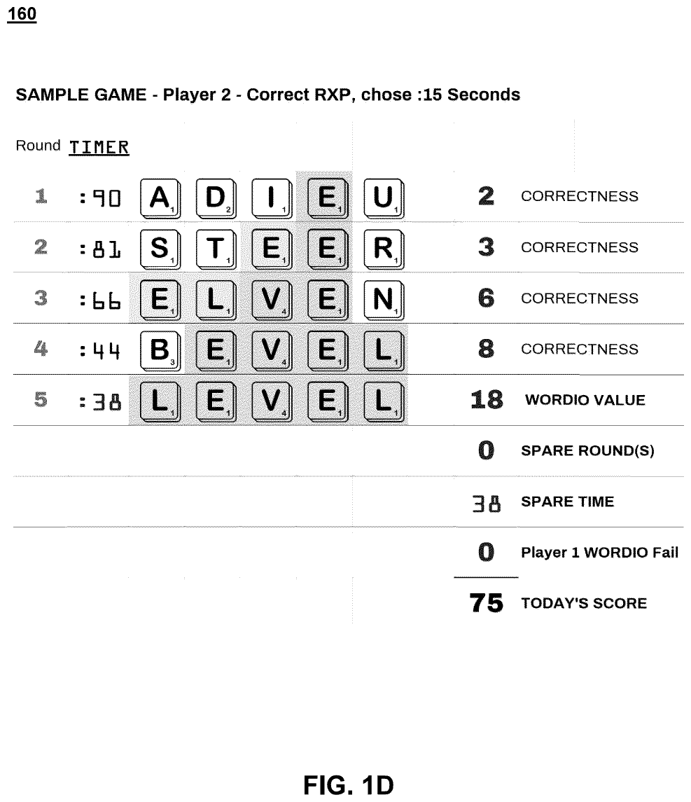

FIG. 1A schematically illustrates an exemplary embodiment of Wordio letter values 100 such as those that may be similar to those used in crossword games, such that letters may have exemplary values in Multi-Player Word Logic Games that may be automated according the disclosed schemes.

As shown in FIG. 1A, point values may be allocated to each letter in the alphabet according to a preset scheme.

For Wordios containing 2 identical letters, points may be added per pair to the Wordio value (e.g., 5 points). Similarly for Wordios containing 3 identical letters, additional points may be added per triplet to the Wordio value (e.g., 15 points).

Lexicon Difficulty may be assessed according to a predetermined scheme and extra points may be added, (e.g., 0, 5, 10, or 15 points based upon which of four lexicons are drawn from for Wordio creation).

TIMED GAME PLAY: Each player may be allocated time to solve the Wordio. For each second saved, the each player may earn points (e.g., 1 point per second).

PARTIAL AND PERFECT POINTS: Each Perfect Match may earn points (e.g., 2 points), each Partial earns points (e.g., 1 point). There may be embodiments that would deduct points for having no Perfect or Partial matches.

ROUND BONUS: Earn points (e.g., 10) for every unused Round

AD REACT BONUS: May uniquely embed advertising in a manner that heightens excitement and directly links paying attention to a positive event in the game being played (e.g., an advantage). Advertising may also provide hosts with an ability to fund web site or application operations and prizes to incentivize larger audiences and time on site and in game. Additionally, a results page for each player may include a link or offer from an advertisement's sponsor, providing more value to brands and the possibility of additional revenues to the game's publisher. In embodiments, a bonus may be based on a player successfully engaging in an RXP that may require that the player provide other information regarding the advertisement, such as sentiment, as opposed to merely verifying comprehension of the advertisement's message.

LEAGUES and TOURNAMENTS: With an ability to provide points and rankings may come an ability to host leagues, teams, and tournaments. In embodiments, various regional newspaper publishers may host regionalized daily games, and weekly scores may enable some players to advance to a weekly one-hour tournament. Because of the speed of play (a WORDIO game may consume less than 5 minutes), multiple players may pair off in a single-elimination model, and within an abbreviated period of time, may crown a weekly champion.

Development of lexicons and word difficulty values may include references to the following. Crossword puzzles may attract word puzzle fans because of the comparatively broad vocabulary that may be required to solve difficult puzzles. Word logic games conventionally have been careful to avoid use of obscure words, likely in order to attract moderate logophiles, or those who wish to expend limited time playing word puzzles. A resulting comparative lack in difficulty in conventional word logic games may serve to actually repel word puzzle enthusiasts who wish to be rewarded and recognized for having a mastery of the language's vocabulary. Development of a system of enabling more advanced players to access an advanced, tiered lexicon may be advantageous.

In embodiments, the WORDIO game may enable players to achieve increasing ranks, measured by frequency of play, average scores, and winning percentages. By way of example, players may climb through a number of different ranks as the player's play WORDIO. All players may, for example, start at an exemplary Level 1, and as a player achieves proficiency and achieves a rank of a top percentage of all players (based upon, for example, average score or win percentage over a defined period of time), a player may climb to an exemplary, more advanced, Level 2. As a player increases in proficiency, reaching progressively higher ranks, the lexicon of words may increase, and in embodiments, higher ranking players may enable play against peers of similar skill levels, such that lower tier players do not become frustrated with having to solve words with which lower tier players may be frequently unfamiliar.

In embodiments, a full vocabulary of 5-letter words may be based on a recognized standard such as a TWL (Tournament Word List) used for word-game tournaments. A current number of approved 5-letter words may be set, for example, in excess of 9,000 words. This full lexicon may be divided into 4 tiers of difficulty, such that approximately 2,200 words (“Tier 1” words) may be included in the lexicon for Level 1 and Level 2 players, consisting of approximately 25% of the available words. In embodiments, Level 1 and Level 2 players may use the same Tier 1 lexicon, such that first advancements in the game are based on players developing a strategy for solving Wordios as opposed to rewarding players with superior vocabularies.

As players increase in skill, and reach Level 3, the lexicon may expand to Tier 2, including a common 50% of the TWL pool of words, which would be in excess of 4,500 words. By way of example, to reach Level 3, a player may need to rank in the top 25% of the population. Wordios added to the Tier 1 list, to make up the Tier 2 list, may have a premium of 5 points added to the overall Wordio value.

In embodiments, a player may not access the Tier 3 lexicon until the player is ranked in the top 5% of all players, at which time the player may have access to 75% of the TWL pool of words, or nearly 7,000 words. Wordios found only in the Tier 3 and Tier 4 list may have a premium of 10 points added to the overall Wordio value.

Finally, the most elite and accomplished players, who rank in the top 1% of all players, may have access to the Tier 4 lexicon, which would consist of the entire TWL pool. Wordios found only in the Tier 4 list may have a premium of 15 points added to the overall Wordio value.

In order to determine the difficulty of a Wordio based on common knowledge of a word's meaning, one could cross reference the pool of approved words against the entire list of all 5-letter “words” appearing on the Internet, as collected and measured by frequency of use by an authority. The list could be culled into only looking at 5-letter words (of which there are at the time of this application, nearly 40,000 words), many of which may include proper nouns, slang, spelling errors, portions of truncated web addresses, foreign words, acronyms, and the like. These would be ranked in order of frequency, highest to lowest, and all words not found in the TWL may be removed, leaving a ranking of frequency for all remaining words.

Other means of ranking words based on frequency of use, or via sampling methods such as polling of large audiences, to develop both a universal list for the full lexicon of eligible Wordios may be recognized and extended as a means of breaking the list into tiers based on each word's familiarity with the community of players.

In embodiments, full Wordio lexicon tiers may be published for all players to see. In order to have access to the list within a tier, a player may be required to have achieved a rank or level where the next tier of words are made available for play.

To illustrate how a Wordio could be assigned a point value, in an exemplary embodiment, the value of a Wordio may comprise of a combination of factors that would add premiums to the value, including:
a. The total of all letter values (e.g., 1-10 points per letter);
b. A premium added when a letter appears twice in a Wordio; and, doubled when two different letters each appear twice in a Wordio (e.g., 5 points per set of two);
c. A premium added when a letter appears three times in a Wordio (e.g., 15 points);
d. A premium based upon the lexicon tier (e.g., Tier 2 Premium of 5, Tier 3 Premium of 10, and Tier 4 premium of 15.

FIG. 1B schematically illustrates an exemplary embodiment of a Wordio scoring model 120 to demonstrate how various Wordio values may be derived according the disclosed schemes, generally as outlined above.

By applying the Wordio scoring model 120 above, FIGS. 1C and 1D schematically illustrate an example of a WORDIO game between two players (a First Player Example 140 and a Second Player Example 160) that may be automated according the disclosed schemes.

In this example, both players may successfully navigate the RXP advertising round, earning a bonus. Player 1 may create “LEVEL” as the Wordio, which is valued at 18 points, while Player 2 may create “MONTH” as the Wordio. Because Player 1 has the more difficult Wordio to be solved, Player 1 may play first. See FIG. 1C, Element 140).

Player 1 may have elected to add a sixth round Bonus (as opposed to adding time to solve the Wordio) and may solve the Wordio “MONTH” in 5 rounds, with 27 of the allotted 75 seconds remaining.

In 4 rounds before solving the Wordio, Player 1 may have collected 4 points by virtue of being awarded 2 Perfect letters in Round 2, and a Partial letter in Rounds 2 and 4.

Because one Round was unused, Player 1 may have received 10 points in addition to 27 points (1 per unused second) and 10 points for the Wordio value itself. Because Player 2 subsequently successfully solves the Wordio, Player 1 may not be awarded any failure points. So, Player 1, according to Example 140, may obtain 53 points.

Player 2 may elect to add: 15 seconds to solve the Wordio, and likewise may solve the Wordio in 5 rounds; with no rounds remaining, Player 2 may not secure a 10 point premium for unused rounds. See FIG. 1D, Element 160).

However, because Player 2 may have added time to solve the puzzle, Player 2 may have been awarded 38 points (one per second remaining), along with 19 points for “correctness” over the four rounds leading up to solving the Wordio.

By solving the Wordio “LEVEL,” Player 2 may be awarded the 18 points attributed for the Wordio value.

As Player 1 may have solved “MONTH,” Player 2 may not have been awarded any failure points.

As a result of the actions of this game, Player 2 may have defeated Player 1, 75-53.

Following the completion of the game, Player 1 may not have elected to challenge Player 2, and a result of the game may, therefore, be factored into each player's win/loss record, average points per game statistic, and overall ranking.

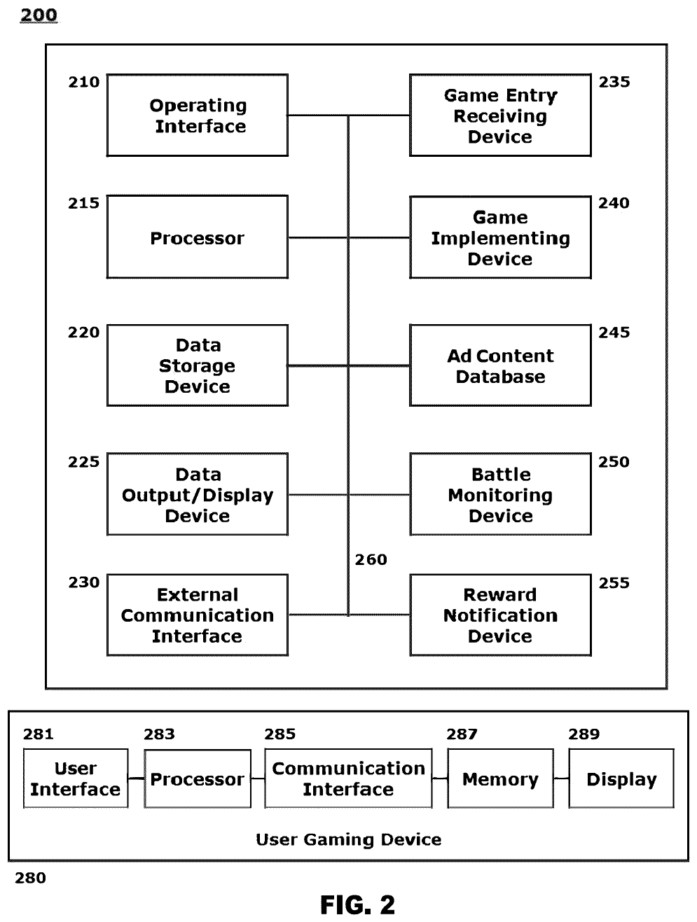

FIG. 2 illustrates a block diagram of an exemplary system 200 for implementing an automated Multi-Player Word Logic Game according to this disclosure.

The exemplary system 200 may include an operating interface 210 by which a user as a host may communicate with the exemplary system 200. The operating interface 210 may provide a host an opportunity initiate the automated Multi-Player Word Logic Game and to input any parameters appropriate to the conduct of the automated Multi-Player Word Logic Game. The operating interface 210 may be configured as one or more conventional mechanisms common to computing and/or communication devices that may permit the host to input information to the exemplary system 200. The operating interface 210 may include, for example, a conventional keyboard, a touchscreen with “soft” buttons or with various components for use with a compatible stylus, a microphone by which the host may provide oral commands to the exemplary system 200 to be “translated” by a voice recognition program, or other like device by which a user may communicate specific operating instructions to the exemplary system 200.

The exemplary system 200 may include one or more local processors 215 for individually operating the exemplary system 200 and for carrying into effect the disclosed schemes in the exemplary system 200. The processor 215 may carry out routines appropriate to operation of the exemplary system 200, and may undertake data manipulation and analysis functions appropriate to the game. Processor(s) 215 may include at least one conventional processor or microprocessor that interprets and executes instructions to direct specific functioning of the exemplary system 200, and control of the automated Multi-Player Word Logic Game implementation according to this disclosure.

The exemplary system 200 may include one or more data storage devices 220. Such data storage device(s) 220 may be used to store data or operating programs to be used by the exemplary system 200, and specifically the processor(s) 215 in carrying into effect the various participant interacting, game displaying and rewards notification functions of the disclosed Multi-Player Word Logic Game schemes. At least one of the data storage device(s) 220 may be used to store the gamification application and to temporarily store in-process Multi-Player Word Logic Game score matrix display information. At least one of the data storage device(s) may be used to store particular identification information that may be collected incumbent to individual participants requesting to play the game. The data storage device(s) 220 may include a random access memory (RAM) or another type of dynamic storage device that is capable of storing updatable database information, and for separately storing instructions for execution of system operations by, for example, processor(s) 215. Data storage device(s) 220 may also include a read-only memory (ROM), which may include a conventional ROM device or another type of static storage device that stores static information and instructions for processor(s) 215. Further, the data storage device(s) 220 may be integral to the exemplary system 200, or may be provided external to, and in wired or wireless communication with, the exemplary system 200, including as cloud-based storage components.

The exemplary system 200 may include at least one data output/display device 225, which may be configured as one or more conventional mechanisms that output information to a user, in this case a host on a progress of the Multi-Player Word Logic Game. The data output/display device 225 may be used to indicate to the host information regarding a compilation of Wordio selections and scores values displays for a particular WORDIO. It is not necessary that the host monitor the actual conduct of the automated Multi-Player Word Logic Game by the exemplary system 200, but the host is afforded that option.

The exemplary system 200 may include one or more separate external communication interfaces 230 by which the exemplary system 200 may communicate with one or more offboard Multi-Player Word Logic Game implementing components including, but not limited to an external display, and any user gaming device 280 on which a participant may choose to play the game, which may be in wired or wireless communication with the exemplary system 200.

The exemplary system 200 may include a game entry receiving device 235 that may be used to receive and store participant registration/identification information for individuals seeking to participate in a particular Multi-Player Word Logic Game. The prospective participant may have to identify information to the exemplary system 200 with which the prospective participant may choose the Multi-Player Word Logic Game be associated, as outlined above. In addition to receiving prospective participant registration/identification information, the game entry receiving device 235 may be usable to interact with the user's gaming device 280 to a user selection of one or more of the plurality of lexicons and Wordios contained therein, and to select, for example, from a matrix that includes a plurality of potential opponents. Participant selection of the one or more of the Wordios and opponents may be according to any of the above discussed methods.

The exemplary system 200 may include a game implementing device 240 that may execute functions for carrying into effect the Multi-Player Word Logic Game according to the disclosed schemes in the exemplary system 200. The game implementing device 240 may itself be a function of the processor 215, or may exist in the exemplary system 200 as a stand-alone component.

The game implementing device 240 may accept input from the game entry receiving device 235 and an Ad Content database 245, in order to store commercial information and associated queries by which to present and collect information according to the bonus applying entry criteria according to the above discussion of REACTing may be applied in the Multi-Player Word Logic Game implemented by the exemplary system 200 is associated.

The exemplary system 200 may include an Battle monitoring device 250 that may be usable to monitor the progress of a plurality of individual WORDIOS in an in-process Multi-Player Word Logic Game. At prescribed intervals, the game implementing device 240 may receive inputs from the Battle monitoring device 250 to, for example, update and display Wordio point values, according to the above schemes, for each of the plurality of Wordio Battles.

The exemplary system 200 may include a reward notification device 255 by which, when a participant is determined to have won a Wordio Battle a prize, award, reward or the like may be identified to which the player winning the Wordio Battle is entitled. Information may then be generated to be sent to a User Gaming Device 280, as will be described in detail below. The prize, award, reward or the like may be in the form of, for example, merchandise, discounts, coupons, cash and/or other incentives. According to inclusion of the reward notification device 255, the user may be immediately notified, and, in the alternative, a challenge according to the above scheme may be initiated. Like the game implementing device 240 above, the reward notification device 255 may be a function of the processor 215, or a stand-alone device, either of which may present reward information to the User Gaming Device 280 of the winning player to be displayed, for example, on a display 289 of the User Gaming Device 280.

The exemplary system 200 may communicate with one or more individual User Gaming Devices 280, each of which may themselves include user interface 281, processor 283, communication interface 285, a memory 287, and a display 289. The user as a participant in a Multi-Player Word Logic Game may employ a User Gaming Device 280 for interaction with the exemplary system 200 as it carries into effect the disclosed schemes for implementing the Multi-Player Word Logic Game. It should be noted that one or more of the User Gaming Devices 280 by which a user may participate in the Multi-Player Word Logic Game may be, in addition to the many device the catalog above, user-wearable devices such as, for example, wearable computer/communicating display glasses and/or watches, biometric sensors, virtual reality (or immersion) devices including goggles, helmets, tactile gloves and the like, and other known or developed wearable components for carrying out one or more of computing and/or communicating functions allowing user to communicate with the exemplary system 200.

All of the various components of the exemplary system 200, as depicted in FIG. 2, may be connected internally, and to one or more external components by one or more data/control busses 260. These data/control busses 260 may provide wired or wireless communication between the various components of the exemplary system 200, whether all of the components of the exemplary system 200 are housed integrally in, or are otherwise external and connected to the exemplary system 200.

It should be appreciated that, although depicted in FIG. 2 as an essentially integral unit, the various disclosed elements of the exemplary system 200 may be arranged in any combination of sub-systems as individual components or combinations of components, integral to a single unit, or external to, and in wired or wireless communication with the single unit of the exemplary system 200. Wireless communications may be by RF radio devices, optical interfaces, NFC devices and other wireless communicating devices according to RF, Wi-Fi, WiGig and other like communications protocols. In other words, no specific configuration as an integral unit, or as a support unit, is to be implied by the depiction in FIG. 2. Further, although depicted as individual units for ease of understanding of the details provided in this disclosure regarding the exemplary interface and control system 200, it should be understood that the described functions of any of the individually-depicted components may be undertaken, for example, by one or more processors 215 connected to, and in communication with, one or more data storage device(s) 220.

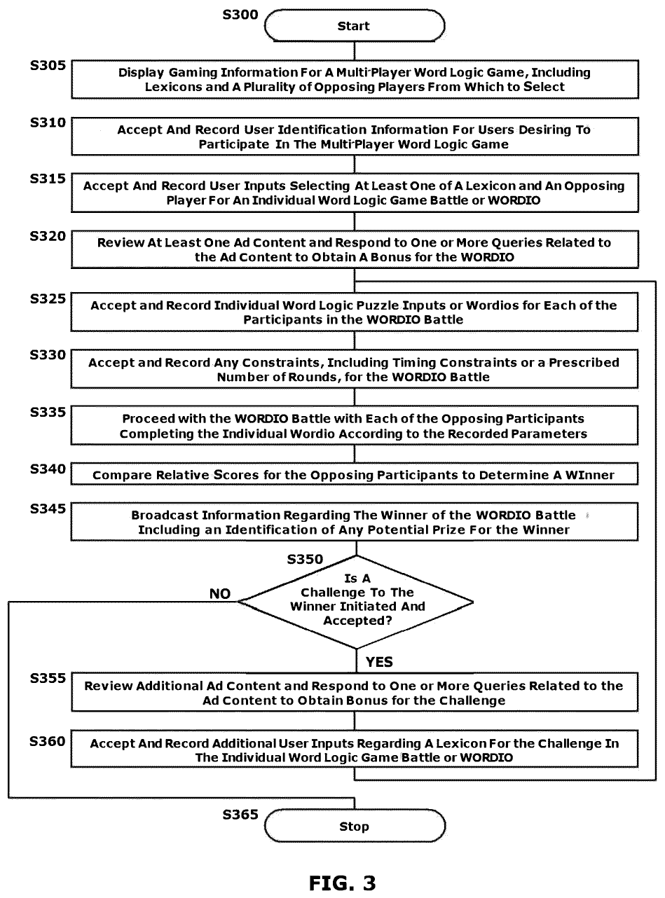

The disclosed embodiments may include an exemplary method for implementing an automated Multi-Player Word Logic Game. FIG. 3 illustrates a flowchart of such an exemplary method. As shown in FIG. 3, operation of the method commences at Step S300 and proceeds to Step S305.

In Step S305, gaming information for a Multi-Player Word Logic Game, including Lexicon Information and a plurality of opposing players from which a player may select, may be displayed. Operation of the method proceeds to Step S310.

In Step S310, user identification information for user desiring to participate in the Multi-Player Word Logic Game may be accepted and recorded. Operation of the method proceeds to Step S315.

In Step S315, user input selecting at least one of a lexicon and an opposing player for an individual Word Logic Game Battle or WORDIO may be accepted and recorded. Operation of the method proceeds to Step S320.

In Step S320, at least one ad content may be reviewed by a user and at least one query related to the ad content may be responded to by the user. A result of the user's response to the query may be evaluated to determine whether a bonus may be applied to the WORDIO Battle. Operation of the method proceeds to Step S325.

In Step S325, individual word logic puzzle inputs or Wordios may be accepted and recorded from each of the participants in the pending WORDIO Battle. Operation of the method proceeds to Step S330.

In Step S330, other qualifiers for the pending WORDIO Battle, including timers and round constraints, may be accepted and recorded from each of the participants in the pending WORDIO Battle. Operation of the method proceeds to Step S335.

In Step S335, the WORDIO Battle is undertaken between the participants according to the details of the schemes outlined above. Operation of the method proceeds to Step S340.

In Step S340, resultant scores of the Wordio Battle are compared to determine a Winner among the participants. Operation of the method proceeds to Step S345.

In Step S345, information regarding the winner for the specified interval may be broadcast to all game participants, including identification of any potential prizes for the winner, as outlined above. Operation the method proceeds to Step S350.

Step S350 is a determination step in which a determination is made as to whether a losing participant in the WORDIO Battel initiates a challenge, and if so, whether that challenge is accepted by the winner at the risk of some detriment to the winning score.

If, in Step S350, a determination is made that no challenge is initiated and accepted, operation of the method proceeds to Step S365, where operation of the method ceases.

If, in Step S350, a determination is made that a challenge is initiated and accepted, operation of the method proceeds to Step S355.

In Step S355, additional ad content may be reviewed by a user and at least one query related to the ad content may be responded to by the user. A result of the user's response to the query may be evaluated to determine whether a bonus may be applied to the challenge. Operation the method proceeds to Step S360.

In Step S360, additional user input selecting a lexicon for the challenge in the individual Word Logic Game Battle or WORDIO may be accepted and recorded. Operation of the method reverts to Step S325.

The disclosed embodiments may include a non-transitory computer-readable medium storing instructions which, when executed by a processor may cause the processor to execute all, or at least some, of the steps of the method outlined above.

The above-described exemplary systems and methods reference certain conventional components to provide a brief, general description of suitable operating and presentation scheme implementing environments in which the subject matter of this disclosure may be undertaken for familiarity and ease of understanding. Although not required, embodiments of the disclosure may be provided, at least in part, in a form of hardware circuits, firmware, or software computer-executable instructions to carry out the specific functions described. These may include individual program modules executed by processors.

Those skilled in the art will appreciate that other embodiments of the disclosed subject matter may be practiced in myriad configurations for carrying into effect the disclosed Multi-Player Word Logic Game schemes with applications hosted on a broad spectrum of computing and communicating devices.

As indicated above, embodiments within the scope of this disclosure may include computer-readable media storing computer-executable instructions or data structures that can be read and executed by one or more processors for controlling the presentation processes for gaming matrices according to the disclosed schemes, and for carrying into effect the overall gaming schemes. Such computer-readable media can comprise RAM, ROM, EEPROM, CD-ROM, flash drives, data memory cards or other analog or digital data storage device that can be used to carry or store desired program elements or steps in the form of accessible computer-executable instructions or data structures.

Computer-executable instructions include, for example, non-transitory instructions and data that can be executed and accessed respectively to cause a processor, for example, in an automated squares game implementing device or system to perform certain of the above-specified data acquisition, game implementation, and display functions. Computer-executable instructions may also include program modules that are remotely stored for access and execution by a processor.

The exemplary depicted sequence of executable instructions or associated data structures represent one example of a corresponding sequence of acts for implementing the functions described in the steps of the above-outlined exemplary method. The exemplary depicted steps may be executed in any reasonable order to carry into effect the objectives of the disclosed embodiments. No particular order to the disclosed steps of the method is necessarily implied by the depiction in FIG. 3, except where a particular method step is a necessary precondition to execution of any other method step. Separately, not all of the depicted steps of the method shown in FIG. 3 need to be implemented in any particular embodiment.

Although the above description may contain specific details, these details should be construed as illustrative and not construed as limiting the disclosure in any way. Other configurations of the described embodiments may be part of the scope of the disclosed embodiments, and in any combination. For example, the principles of the disclosed embodiments may be applied to each individual user/consumer that may independently access features of the disclosed WORDIO game play information exchange, verification and reward systems and/or schemes. This would enable each user/consumer to utilize the benefits of the disclosed embodiments even if any one of a large number of possible applications do not need all of the described functionality. In other words, there may be multiple instances of the disclosed systems and methods each being separately employed in various possible ways at the same time where the actions of one user do not necessarily affect actions of other users using separate/discrete embodiments, or combinations thereof.

We claim:

1. A system for implementing multi-player word logic game, comprising:
a display device for displaying information regarding the word logic game; and
a gamification device that is configured to
direct display of the information on the display device including information defining lexicon parameters and a plurality of opposing players;
receive user selection of a lexicon and an individual opposing player among the plurality of opposing players transmitted from a user-controlled electronic device;
receive a first word logic puzzle from the user and a second word logic puzzle from the selected individual opposing player;
receive a first solution to the first word logic puzzle from the selected individual opposing player;
assign a first point value to the first solution according to a stored scheme;
receive a second solution to the second word logic puzzle from the user;
assign a second point value to the second solution according to the stored scheme; and
compare the first point value and the second point value to determine a winner of the word logic game.
